(19) United States
(12) Patent Application Publication
(10) Pub. No.: US 2007/0091529 A1
(43) Pub. Date: Apr. 26, 2007

(54) OVERLOAD DETECTION AND INDICATION

(76) Inventor: Richard Lee Clark, Burlington, NC (US)

Correspondence Address: ADAMS EVANS P.A., 301 SOUTH TRYON STREET, SUITE 2180, TWO WACHOVIA CENTER, CHARLOTTE, NC, 28282-1991, US

(21) Appl. No.: 11/551,267

(22) Filed: Oct. 20, 2006

Related U.S. Application Data
(60) Provisional application No. 60/596,856, filed on Oct. 26, 2005.

(51) Int. Cl. H02H 3/08

(52) U.S. Cl. 361/93.1

(57) ABSTRACT

An electrical apparatus with electrical overload indication having a conductor for transmitting electrical current, a sense lead, and an indication circuit. The sense lead is electrically connected to the conductor for sensing a voltage drop in the conductor. The indication circuit is electrically connected to the sense lead for comparing the voltage drop in the conductor to a predetermined voltage drop, and providing an indication of an overload condition when the voltage drop exceeds the predetermined voltage drop.

### CROSS-REFERENCE TO RELATED APPLICATIONS

This application claims the benefit of Provisional Application No. 60/596,856 filed on Oct. 26, 2005.

### TECHNICAL FIELD AND BACKGROUND OF THE INVENTION

The present invention relates to the field of overload detection and indication. In particular, the invention relates to an electrical apparatus having an indicator for indicating an electrical overload.

Electrical overload protection is of major concern when dealing with electrical systems and devices. As a result, circuit breaking technology has been installed in homes, electrical devices, and electrical cords. When an overload condition occurs, the circuit breaker breaks the electrical connection, thereby preventing current from flowing therethrough. However, while circuit breakers are effective in stopping current flow, they do not provide any kind of warning that an overload is occurring.

U.S. Pat. No. 6,005,484 discloses a warning device that detects an overload or overheating in electrical cords, cables, or sockets. The warning device uses a plurality of warning strips positioned along a power cord. The warning strips are covered with a dark heat-sensing layer that gradually turns transparent as it is heated to reveal the warning strips, thereby warning a user that an overload is occurring. However, there are disadvantages associated with this method of detection. For example, the warning strips must be positioned where the overheating occurs. If a hot spot occurs in a location of the cord absent warning strips, no indication will be given. Also, the transparency rate of the heat-sensing layer is gradual, and is based on the amount of heat generated by an overload. This may result in a slow indication time or in the case of a user having poor eye-sight, no indication at all. Thus, the overload condition may exist for a substantial period of time before a user notices the warning strip.

Accordingly, there is a need for an electrical apparatus with an overload indicator that can instantly and positively indicate to a user that an electrical overload is occurring, and that can detect and indicate an overload condition across the entire apparatus.

### SUMMARY OF THE INVENTION

Therefore, it is an object of the invention to provide an electrical apparatus capable of instantly indicating an overload condition.

It is another object of the invention to provide an electrical apparatus capable of visually or audibly indicating an overload condition.

It is another object of the invention to provide an electrical apparatus that can be used in an alternating current system.

It is another object of the invention to provide an electrical apparatus that can detect an overload condition across the entire apparatus.

These and other objects of the present invention are achieved in the preferred embodiments disclosed below by providing an electrical apparatus with electrical overload indication. The electrical apparatus includes a conductor for transmitting an electrical current; a sense lead electrically connected to the conductor for sensing a voltage drop in the conductor; and an indication circuit electrically connected to the sense lead for comparing the voltage drop in the conductor to a predetermined voltage drop and providing an indication of an overload condition when the voltage drop exceeds the predetermined voltage drop.

According to another preferred embodiment of the invention, the indication circuit receives an electrical current representative of the voltage drop in the conductor from the sense lead.

According to another preferred embodiment of the invention, the indication circuit includes an indicator for indicating the overload condition.

According to another preferred embodiment of the invention, the indication circuit includes an encapsulated chip for comparing the voltage drop to the predetermined voltage drop and activating the indicator.

According to another preferred embodiment of the invention, the indicator provides a visual indication of the overload condition.

According to another preferred embodiment of the invention, the indicator provides an audible indication of the overload condition.

According to another preferred embodiment of the invention, the electrical current is an alternating current.

According to another preferred embodiment of the invention, the indication circuit is adapted to rectify the alternating current into a representative magnitude of the voltage drop in the conductor.

According to another preferred embodiment of the invention, the indication circuit integrates the alternating current to allow proper measurement of the voltage drop in the conductor.

According to another preferred embodiment of the invention, the sense lead is insulated from the conductor.

According to another preferred embodiment of the invention, a power cord with electrical overload indication includes an electrical cord having a hot conductor and a neutral conductor for transmitting an electrical current to an electrical device; a sense lead electrically connected to opposing ends of the electrical cord for sensing a voltage drop across the electrical cord; and an indication circuit electrically connected to the sense lead for comparing the voltage drop to a predetermined voltage drop, and providing an indication of an overload condition when the voltage drop exceeds the predetermined voltage drop.

According to another preferred embodiment of the invention, when a voltage drop occurs across the hot conductor, a portion of the electrical current representative of the voltage drop is transmitted through the sense lead to the indication circuit.

According to another preferred embodiment of the invention, the indication circuit is adapted to rectify the electrical current into a half-wave direct current signal having a representative magnitude of the voltage drop in the electrical cord.

According to another preferred embodiment of the invention, the indication circuit is adapted to rectify the electrical current into a full-wave direct current signal having a representative magnitude of the voltage drop in the electrical cord.

According to another preferred embodiment of the invention, the indication circuit includes an indicator adapted to indicate an overload condition when the voltage drop exceeds the predetermined voltage drop.

According to another preferred embodiment of the invention, and further including a male plug electrically connected to a first end of the electrical cord for being inserted into an electrical outlet.

According to another preferred embodiment of the invention, and further including a female receptacle electrically connected to a second end of the electrical cord for receiving a male plug of the electrical device.

According to another preferred embodiment of the invention, the sense lead is electrically connected to opposing ends of the hot conductor.

According to another preferred embodiment of the invention, a speaker cable with overload indication including a sense lead electrically connected to the cable to receive a portion of an audio signal from the cable; and an indication circuit electrically connected to the sense lead for comparing a magnitude of the signal to a predetermined magnitude, and providing an indication of an overload condition when the magnitude of the signal exceeds the predetermined magnitude.

According to another preferred embodiment of the invention, the indication circuit includes an indicator adapted to indicate an overload condition when the magnitude of the signal exceeds the predetermined magnitude.

According to another preferred embodiment of the invention, the indication circuit is adapted to rectify the signal into a full-wave direct current signal having a representative magnitude of the signal in the positive conductor.

According to another preferred embodiment of the invention, the speaker cable includes a positive conductor and a negative return conductor for transmitting the signal to a speaker.

According to another preferred embodiment of the invention, the sense lead is electrically connected to opposing ends of the positive conductor.

According to another preferred embodiment of the invention, the speaker cable transmits the audio signal from an audio system to a speaker.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 shows a power cord according to an embodiment of the invention;

FIG. 2 is a cross-section of the power cord of FIG. 1;

FIG. 3 is a partial cut-away of the power cord of FIG. 1;

FIG. 4 is a schematic of the power cord of FIG. 1;

FIG. 5 shows a schematic of a speaker cable according to an embodiment of the invention; and

FIG. 6 is a schematic of an audio system using the speaker cable of FIG. 5.

### DESCRIPTION OF THE PREFERRED EMBODIMENT AND BEST MODE

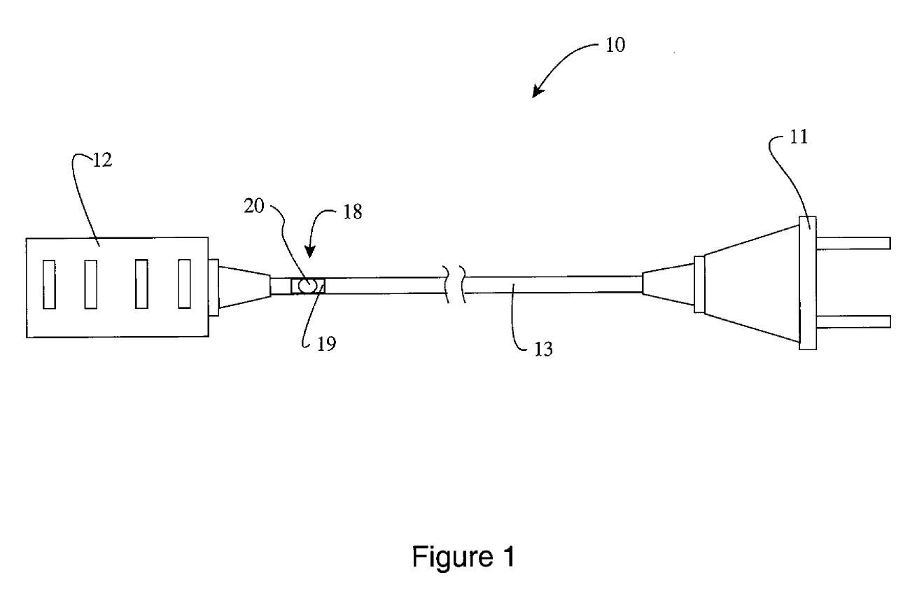

Referring now specifically to the drawings, a power cord according to an embodiment of the invention is illustrated in FIGS. 1-4 and shown generally at reference numeral 10.

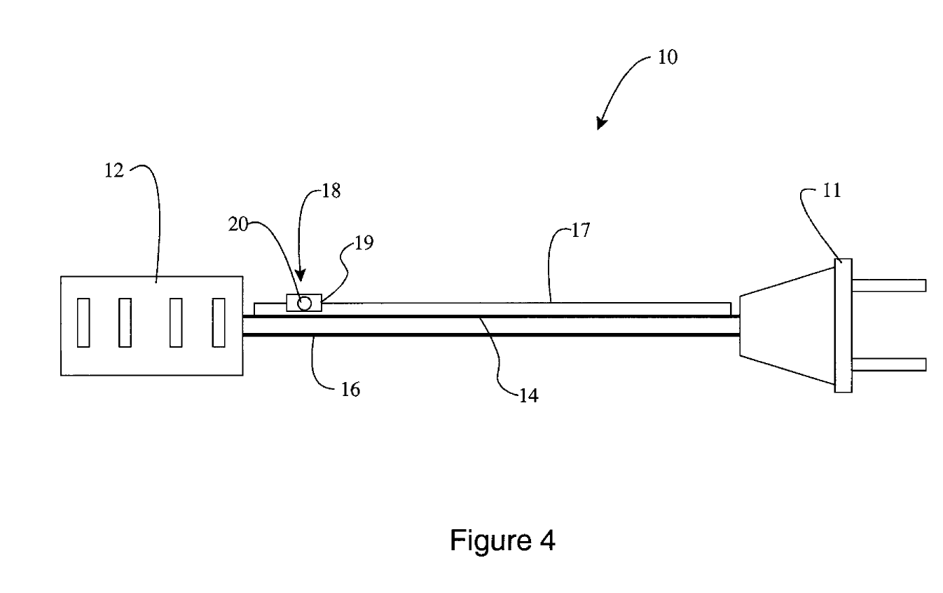

The power cord 10 includes a male plug 11 for being inserted into an electrical wall outlet, a female receptacle 12 for receiving a male plug of an electrical device, and an electrical cord 13 electrically connecting the male plug 11 to the female receptacle 12. The electrical cord 13 includes a hot conductor 14 for transmitting an electrical current, a neutral return conductor 16, and a sense lead 17 electrically connected to opposing ends of the hot conductor 14, as shown in FIG. 4. An indication circuit 18 is electrically connected to the sense lead 17 to provide an indication of an electrical overload within the power cord 10.

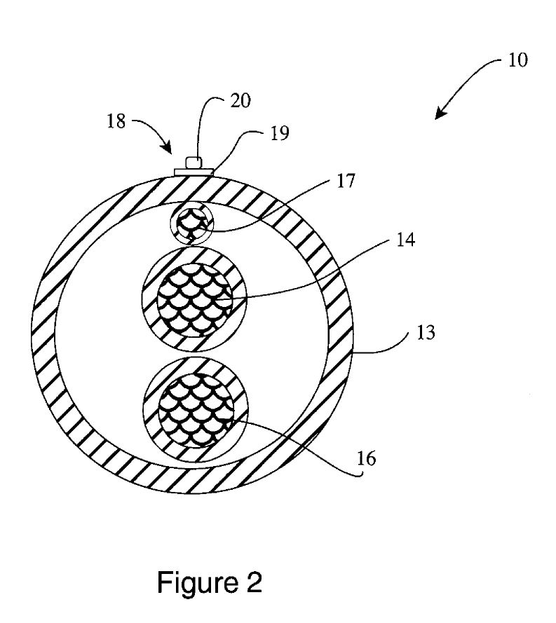

As shown in FIG. 2, the sense lead 17 is smaller than the hot conductor 14 and neutral conductor 16, since the sense lead 17 only carries enough current to allow the indication circuit 18 to sense an overload condition. The sense lead 17 is insulated from and may be molded with the hot conductor 14.

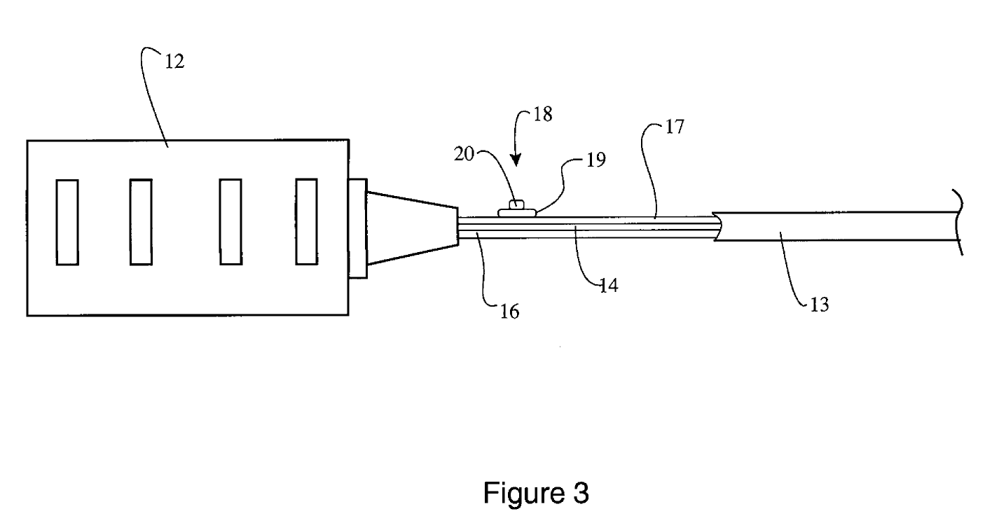

Referring to FIGS. 3 and 4, the indication circuit 18 may be positioned on either end of the power cord 10, and is responsible for sensing, measuring, and indicating an overload condition. The indication circuit 18 includes a board or an encapsulated chip 19 and an indicator 20. The indicator 20 may provide a visual or audible indication of an overload condition.

In operation, the power cord 10 is made of a fixed length with a known current carrying capacity rating. Under normal conditions the power cord 10 supplies current to an electrical device. The hot conductor 14 and neutral return conductor 16 carry the full load of the device being supplied. As multiple electrical devices are plugged into the power cord 10 the current in the power cord 10 increases. This increase in current causes the voltage drop along the hot conductor 14 and neutral return wire 16 to also increase. The higher the voltage drop, the more current passes through the sense lead 17 and indication circuit 18. Upon reaching a predetermined voltage drop, the indication circuit 18 turns on the indicator 20 to warn the user of an overload condition. This is different from a circuit breaker as it does not break the electrical connection, thereby preventing current from flowing therethrough. Instead, the power cord 10 helps prevent an overload condition by warning a user that too many electrical devices are plugged into the power cord 10.

Since the power cord 10 is used in an alternating current (AC) system, the current being sensed by the sense lead 17 is rectified to allow proper measurement of the voltage drop. The indication circuit 18 rectifies the AC signal into either a half-wave or full-wave DC signal so that a representative magnitude of the signal may be measured. The rectified AC signal may then be integrated to increase the accuracy of the measured signal. Once the AC signal has been rectified and integrated, the indication circuit 18 measures the voltage drop across the power cord 10.

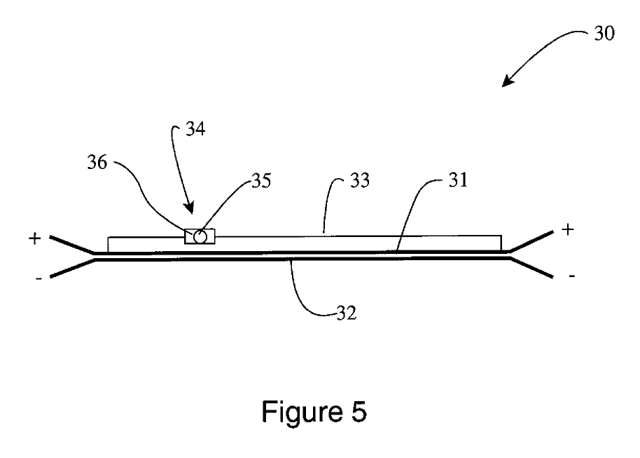

Referring to FIG. 5, a speaker cable according to an embodiment of the invention is shown generally at reference numeral 30. The speaker cable 30 includes a positive conductor 31 for transmitting a signal representative of speech and music, a negative return conductor 32, a sense lead 33 electrically connected to opposing ends of the positive conductor, and an indication circuit 34, having a board or an encapsulated chip 36 and an indicator 35, electrically connected to the sense lead 33 to provide an indication of an electrical overload within the speaker cable 30.

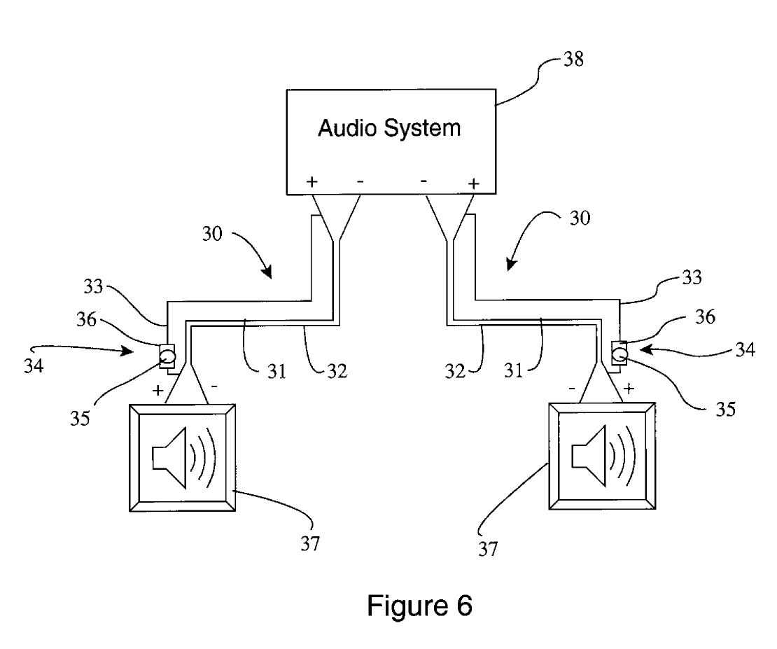

As shown in FIG. 6, the speaker cables 30 electrically connect an audio system 38 to a pair of speakers 37. The audio system 38 provides audio signals or current representing speech and music to the speakers 37 via the speaker cables 30. Since the signal being transmitted by the speaker cables 30 is a complex representation of speech and music, the indication circuit 34 provides full-wave rectification of the signal so that a representative magnitude of the signal may be measured. The rectified signal may then be integrated. Once the signal has been rectified and integrated, the indication circuit 34 measures the signal across the speaker cable 30 and activates the indicator 35 when an overload condition occurs.

An electrical apparatus with a indicator is described above. Various details of the invention may be changed without departing from its scope. Furthermore, the foregoing description of the preferred embodiments of the invention and the best mode for practicing the invention are provided for the purpose of illustration only and not for the purpose of limitation.

I claim:

1. An electrical apparatus with electrical overload indication, comprising:
(a) a conductor for transmitting an electrical current;
(b) a sense lead electrically connected to the conductor for sensing a voltage drop in the conductor; and
(c) an indication circuit electrically connected to the sense lead operable to compare the voltage drop in the conductor to a predetermined voltage drop and provide an indication of an overload condition when the voltage drop exceeds the predetermined voltage drop.

2. The electrical apparatus according to claim 1, wherein the indication circuit receives an electrical current representative of the voltage drop in the conductor from the sense lead.

3. The electrical apparatus according to claim 1, wherein the indication circuit includes an indicator for indicating the overload condition.

4. The electrical apparatus according to claim 3, wherein the indication circuit includes an encapsulated chip for comparing the voltage drop to the predetermined voltage drop and activating the indicator.

5. The electrical apparatus according to claim 3, wherein the indicator provides a visual indication of the overload condition.

6. The electrical apparatus according to claim 3, wherein the indicator provides an audible indication of the overload condition.

7. The electrical apparatus according to claim 2, wherein the electrical current is an alternating current.

8. The electrical apparatus according to claim 7, wherein the indication circuit is adapted to rectify the alternating current into a representative magnitude of the voltage drop in the conductor.

9. The electrical apparatus according to claim 8, wherein the indication circuit integrates the alternating current to measure the voltage drop in the conductor.

10. The electrical apparatus according to claim 1, wherein the sense lead is insulated from the conductor.

11. A power cord with electrical overload indication, comprising:
(a) an electrical cord having a hot conductor and a neutral conductor for transmitting an electrical current to an electrical device;
(b) a sense lead electrically connected to opposing ends of the electrical cord for sensing a voltage drop across the electrical cord; and
(c) an indication circuit electrically connected to the sense lead for comparing the voltage drop to a predetermined voltage drop, and providing an indication of an overload condition when the voltage drop exceeds the predetermined voltage drop.

12. The power cord according to claim 11, wherein, when a voltage drop occurs across the electrical cord, a portion of the electrical current representative of the voltage drop is transmitted through the sense lead to the indication circuit.

13. The power cord according to claim 12, wherein the indication circuit is adapted to rectify the electrical current into a half-wave direct current signal having a representative magnitude of the voltage drop in the electrical cord.

14. The power cord according to claim 12, wherein the indication circuit is adapted to rectify the electrical current into a full-wave direct current signal having a representative magnitude of the voltage drop in the electrical cord.

15. The power cord according to claim 11, wherein the indication circuit includes an indicator adapted to indicate an overload condition when the voltage drop exceeds the predetermined voltage drop.

16. The power cord according to claim 11, and further including a male plug electrically connected to a first end of the electrical cord for being inserted into an electrical outlet.

17. The power cord according to claim 11, and further including a female receptacle electrically connected to a second end of the electrical cord for receiving a male plug of the electrical device.

18. The power cord according to claim 11, wherein the sense lead is electrically connected to opposing ends of the hot conductor.

19. A speaker cable with overload indication, comprising:
(a) a sense lead electrically connected to the cable to receive a portion of an audio signal from the cable; and
(b) an indication circuit electrically connected to the sense lead for comparing a magnitude of the signal to a predetermined magnitude, and providing an indication of an overload condition when the magnitude of the signal exceeds the predetermined magnitude.

20. The speaker cable according to claim 19, wherein the indication circuit includes an indicator adapted to indicate an overload condition when the magnitude of the signal exceeds the predetermined magnitude.

21. The speaker cable according to claim 19, wherein the indication circuit is adapted to rectify the signal into a full-wave direct current signal having a representative magnitude of the signal in the positive conductor.

22. The speaker cable according to claim 19, wherein the speaker cable includes a positive conductor and a negative return conductor for transmitting the signal to a speaker.

23. The speaker cable according to claim 22, wherein the sense lead is electrically connected to opposing ends of the positive conductor.

24. The speaker cable according to claim 19, wherein the speaker cable transmits the audio signal from an audio system to a speaker.
